(19) United States
(12) Patent Application Publication
(10) Pub. No.: US 2023/0098911 A1
(43) Pub. Date: Mar. 30, 2023

(54) Shedding Cover Device for Pet Beds

(71) Applicant: Jordan Schneider, Granbury, TX (US)

(72) Inventor: Jordan Schneider, Granbury, TX (US)

(21) Appl. No.: 17/711,573

(22) Filed: Apr. 1, 2022

Related U.S. Application Data
(60) Provisional application No. 63/246,907, filed on Sep. 22, 2021.

(51) Int. Cl. A01K 1/035; A47C 31/10

(52) U.S. Cl. CPC A01K 1/0353; A47C 31/10

(57) ABSTRACT

The present invention relates to a shedding cover device for pet beds that is primarily comprised of a body that has a top surface, a side surface, and an internal pocket that receives a rubber mat insert. The body is preferably comprised of a nylon or fiber-mesh material that conducts static electricity and can be applied to any shape and size of pet bed known in the art. The top surface further has a continuous opening that exposes a bristled, rubber mat. The bristles of the mat de-shed a pet when the pet lays on the pet bed. Further, the interaction between the body and the mat generates static electricity which creates a static cling effect. This effect then further attracts loose hairs of a pet to further de-shed the pet and capture any hair removed from the bristles of the mat

### CROSS-REFERENCE TO RELATED APPLICATION

The present application claims priority to, and the benefit of, U.S. Provisional Application No. 63/246,907, which was filed on Sep. 22, 2021 and is incorporated herein by reference in its entirety.

### FIELD OF THE INVENTION

The present invention relates generally to the field of de-shedding animals. More specifically, the present invention relates to a shedding cover device for pet beds that is primarily comprised of a body that has a top surface, a side surface and an internal pocket that receives a rubber mat insert. The body is preferably comprised of a nylon or fiber-mesh material that conducts static electricity and can be applied to any shape and size of pet bed known in the art. The top surface further has a continuous opening that exposes a bristled, rubber mat. The bristles of the mat de-shed a pet when the pet lays on the pet bed. Further, the interaction between the body and the mat generates static electricity which creates a static cling effect. Accordingly, the present disclosure makes specific reference thereto. Nonetheless, it is to be appreciated that aspects of the present invention are also equally applicable to other like applications, devices and methods of manufacture.

### BACKGROUND

There are approximately 48 million dog owners and 32 million cat owners in the United States. Although cats and dogs make wonderful pets, most cat breeds and a large portion of dog breeds shed. This is especially true during the spring and fall seasons. In order to prevent shedding, a pet owner must regularly brush his or her pet on a daily basis. However, this is undesirable, as depending on the size of the pet, this process can be very involved and time-consuming. Further, this process results in hair being brushed from the pet and onto the surrounding area, which then must be collected. Because of the demands involved in brushing pets that shed frequently, a pet owner may simply choose to not brush his or her pet. However, this will result in excessive shedding of the pet, which then covers the surfaces, furniture, clothing and objects within a pet owner’s home. This is equally undesirable, as the surfaces, furniture, clothing and objects must then be cleaned, dusted and/or vacuumed. In addition, many pet owners purchase beds for their pets, wherein the pet lays in the bed while sleeping or relaxing.

Therefore, there exists a long-felt need in the art for a device that reduces pet shedding. There is also a long-felt need in the art for a device that reduces pet shedding, that also does not require that a user brush his or her pet. Finally, there exists a long-felt need in the art for a shedding cover device for pet beds that can be removably-applied to a pet bed to de-shed the pet, as the pet lounges or sleeps on the bed.

The subject matter disclosed and claimed herein, in one embodiment thereof, comprises a shedding cover device for pet beds. The device is primarily comprised of a body that has a top surface, a side surface and an internal pocket that receives a rubber mat insert. The body is preferably comprised of a nylon or fiber-mesh material that conducts static electricity and can be applied to any shape and size of pet bed known in the art. In doing so, the body preferably covers the top surface, side surfaces and/or bottom surface of the bed. The top surface further has a continuous opening that exposes a bristled, rubber mat. The bristles of the mat further de-shed a pet when the pet lays on the pet bed. Furthermore, the interaction between the body and the mat generates static electricity which creates a static cling effect. This effect then further attracts the loose hairs of a pet to further de-shed the pet and capture any hair removed from the bristles of the mat.

In this manner, the shedding cover device for pet beds of the present invention accomplishes all of the forgoing objectives and provides a device that does not require a user to brush the pet to achieve a reduction in shedding. Further, the device can be removably applied to a pet bed in order to de-shed the pet, as the pet lounges or sleeps on the bed. In this manner, the shedding cover device for pet beds overcomes the limitations of existing de-shedding practices and methods known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a shedding cover device for pet beds. The device is primarily comprised of a body that has a top surface, a side surface, and an internal pocket that receives a rubber mat insert. The body is preferably comprised of a nylon or fiber-mesh material that conducts static electricity and can be applied to any shape and size of pet bed known in the art. In doing so, the body preferably covers the top surface, side surfaces and/or bottom surface of the bed. To removably-secure the device to a bed, the side surfaces are further comprised of at least one elastic band that presses against the side surfaces of the pet bed to further provide a compressive force to ensure the device remains secured to the bed.

The top surface of the body has at least one continuous opening that does not expose the top surface of the pet bed but does expose the interior surface of the bed that a pet lays on while using the bed. The opening also exposes a rubber mat insert wherein the top surface of the mat is comprised of a plurality of bristles. The bristles may be manufactured from a rubber, metal or plastic material. Further, the bristles de-shed a pet while the pet lays on the device, while the device is applied to a pet bed. In addition, the rubber material of the mat and the material of the body generate static electricity when a pet lays on the device and rubs on the body to create static cling. This static cling then attracts loose hairs of the pet and any hairs that are de-shed from the pet via the mat. As a result, the body and mat de-sheds and collects hair from a pet any time the pet lays on the device, while the device covers a pet bed.

In order to retain the mat within the device, the device has an internal pocket that sits below the continuous opening and allows the mat to be stored within the body, such that the mat cannot fall out of the body while in use. The mat can further be removed from the pocket to allow a user to clean the mat and/or remove hair from the mat. The side surface of the pocket may further be comprised of at least one fastener that allows a user to close the pocket, such that the mat cannot exit the pocket. The bottom surface of the pocket may also be comprised of a loop surface that engages a hook surface on the bottom surface of the mat. In this regard, the mat is further removably secured within the pocket. In differing embodiments, an alternative fastening means can be substituted for the loop surface and the hook surface.

Accordingly, the shedding cover device for pet beds of the present invention is particularly advantageous as it reduces pet shedding. Further, the device does not require that a user must brush his or her pet to achieve the reduction in shedding. Finally, the device can be removably applied to a pet bed to de-shed the pet as the pet lounges or sleeps on the bed. In this manner, the shedding cover device for pet beds overcomes the limitations of existing de-shedding practices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the shedding cover device for a pet bed of the present invention in accordance with the disclosed architecture, wherein the shedding cover device is attached to a pet bed;

FIG. 2 illustrates an enhanced perspective view of one potential embodiment of the rubber mat insert of the shedding cover device for a pet bed of the present invention in accordance with the disclosed architecture; and

FIG. 3 illustrates a cross-sectional view of one potential embodiment of the shedding cover device for a pet bed of the present invention attached to a pet bed in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that reduces pet shedding. There is also a long-felt need in the art for a device that reduces pet shedding and also does not require a user to brush his or her pet. Finally, there exists a long-felt need in the art for a shedding cover device for pet beds that can be removably-applied to a pet bed to de-shed the pet as the pet lounges or sleeps on the bed.

The present invention, in one exemplary embodiment, is comprised of a shedding cover device for pet beds primarily comprised of a body that has a top surface, a side surface, and an internal pocket that receives a rubber mat insert. The body is preferably comprised of a nylon or fiber-mesh material that conducts static electricity and can be applied to any shape and size of pet bed known in the art. The body preferably covers the top surface, side surfaces, and/or bottom surface of the bed and is removably-secured to a bed via at least one elastic band that presses against the side surfaces of the pet bed to further provide a compressive force to ensure the device remains secured to the bed.

The top surface of the body has at least one continuous opening that does not expose the top surface of the pet bed, but does expose the interior surface of the bed that a pet lays on while using the bed. The opening also exposes a rubber mat insert wherein the top surface of the mat is comprised of a plurality of bristles. The bristles may be manufactured from a rubber, metal or plastic material. Further, the bristles de-shed a pet while the pet lays on the device, while the device has been applied to a pet bed. In addition, the rubber material of the mat and material of the body generate static electricity when a pet lays on the device and rubs on the body, which creates static cling. This static cling then attracts loose hairs of the pet and any hairs that are de-shedded from the pet via the mat. As a result, the body and mat de-sheds and collects hair from a pet any time the pet lays on the device, while the device covers a pet bed.

The device also has an internal pocket that sits below the continuous opening and allows the mat to be stored within the body, such that the mat cannot fall out of the body while in use. The mat can further be removed from the pocket to allow a user to clean the mat and/or remove hair from the mat. The side surface of the pocket may further be comprised of at least one fastener that allows a user to close the pocket, such that the mat cannot exit the pocket. The bottom surface of the pocket may also be comprised of a loop surface that engages a hook surface on the bottom surface of the mat. In this regard, the mat is further removably-secured within the pocket. In differing embodiments, an alternative fastening means can be substituted for the loop surface and the hook surface.

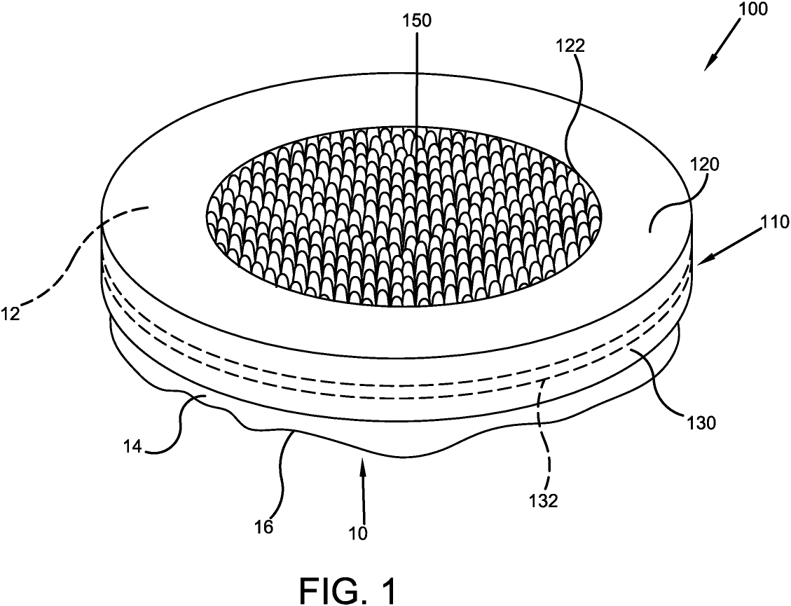

Referring initially to the drawings, FIG. 1 illustrates a perspective view of one embodiment of the shedding cover device for pet beds 100 of the present invention while attached to a pet bed. The device 100 is preferably comprised of a body 110 that has a top surface 120, a side surface 130, and an internal pocket 140 that receives a rubber mat insert 150. The body 110 is preferably comprised of a nylon or fiber-mesh material that conducts static electricity. However, in differing embodiments, the body 110 may be comprised of any suitable material known in the art that conducts static electricity. The body 110 can further be applied to any shape and size of pet bed 10 known in the art, wherein the body 110 preferably covers the top surface 12, side surfaces 14, and/or bottom surface 16 of the pet bed 10. Alternatively, the device 100 may be comprised of a pet bed 10, wherein the device 100 is fixedly-attached to the pet bed 10. To removably-secure the device 100 to a pet bed 10, the side surfaces 130 are further comprised of at least one elastic band 132. The elastic band 132 presses against the side surfaces 14 of the pet bed 10 to further provide a compressive force to ensure the device 100 remains secured to the pet bed 10.

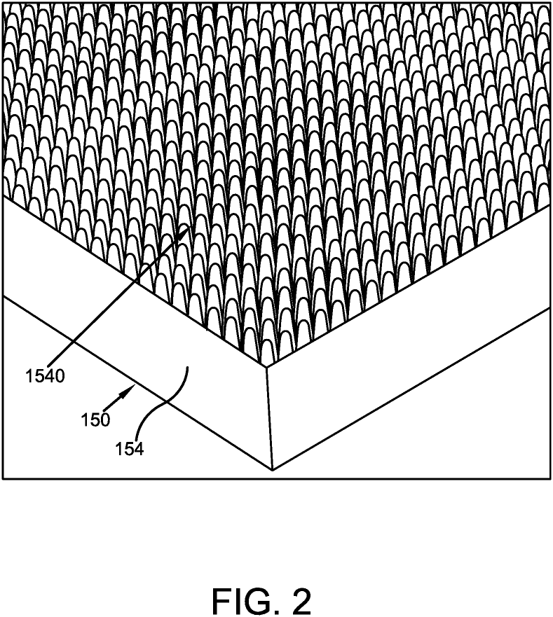

As shown in FIG. 2, the top surface 120 of the body 110 is further comprised of at least one continuous opening 122. The continuous opening 122 is preferably positioned on the top surface 120, such that the continuous opening 122 does not expose the top surface 12 of the pet bed 10 but does expose the interior surface (not shown) of the bed 10 that a pet lays on while using the bed 10. The opening 122 also exposes a rubber mat insert 150. As seen in FIG. 2, the top surface 154 of the mat 150 is comprised of a plurality of bristles 1540 that in one embodiment, may be similar in structure to bristles found on a pet brush. In differing embodiments, the bristles 1540 may be manufactured from a rubber, metal, or plastic material, etc., or any other suitable material as is known in the art. Further, the bristles 1540 de-shed a pet, while the pet lays on the device 100 when the device 100 has been applied to a pet bed 10. The rubber material of the mat 150 and material of the body 110 also generate static electricity, when a pet lays on the device 100 and rubs on the body 110. To this effect, static cling is created. This static cling then attracts loose hairs of the pet, and any hairs that are de-shedded from the pet via the mat 150. Therefore, the body 110 and mat 150 de-sheds and collects hair from a pet any time the pet lays on the device 100, while the device 100 covers a pet bed 10.

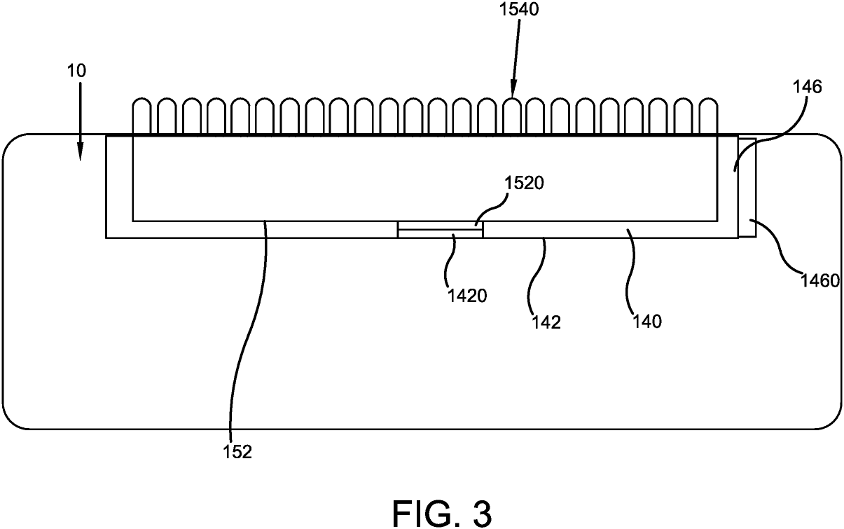

FIG. 3 illustrates a cross-sectional view of one embodiment of the shedding cover device for pet beds 100 of the present invention while attached to a pet bed 10. In order to retain the mat 150 within the device 100, the device 100 is comprised of an internal pocket 140 that sits below the continuous opening 122. The pocket 140 allows the mat 150 to be stored within the body 110, such that the mat 150 cannot fall out of the body 110 while in use. The mat 150 can further be removed from the pocket 140 to allow a user to clean the mat 150 and/or remove hair from the mat 150. To further retain the mat 150 in the pocket 140, the side surface 146 of the pocket 140 may further be comprised of at least one fastener 1460 that allows a user to close the pocket 140, such that the mat 150 cannot exit the pocket 140.

In differing embodiments, the fastener 1460 may be any fastener known in the art, such as but not limited to: hook and loop, zipper assembly, snap-button assembly, button and loop assembly, magnetic, etc. In addition, the bottom surface 142 of the pocket 140 may be comprised of a loop surface 1420 that engages a hook surface 1520 on the bottom surface 152 of the mat 150. In this regard, the mat 150 is further removably-secured within the pocket 140. In differing embodiments, an alternative fastening means can be substituted for the loop surface 1420 and the hook surface 1520, wherein the means includes but is not limited to: hook and loop, zipper assembly, snap-button assembly, button and loop assembly, magnetic, etc.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “shedding cover device for pet beds” and “device” are interchangeable and refer to the shedding cover device for pet beds 100 of the present invention.

Notwithstanding the forgoing, the shedding cover device for pet beds 100 of the present invention and its various components can be of any suitable size and configuration as is known in the art without affecting the overall concept of the invention, provided that they accomplish the above-stated objectives. One of ordinary skill in the art will appreciate that the size, configuration and material of the shedding cover device for pet beds 100 as shown in FIGS. 1-3 is for illustrative purposes only, and that many other sizes and shapes of the shedding cover device for pet beds 100 are well within the scope of the present disclosure. Although the dimensions of the shedding cover device for pet beds 100 are important design parameters for user convenience, the shedding cover device for pet beds 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shedding cover device that can be removably applied to a pet bed to de-shed a pet as the pet is positioned on the pet bed, the shedding cover device comprising:
a body comprising a top surface and a side surface;
an internal pocket;
a rubber mat; and
a plurality of bristles extending outwardly from the rubber mat.

2. The shedding cover device of claim 1, wherein the plurality of bristles extend outwardly from a top surface of the rubber mat.

3. The shedding cover device of claim 1, wherein the rubber mat and the body generate a static electricity.

4. The shedding cover device of claim 3, wherein the body and the rubber mat collect hair from the pet.

5. A pet bed shedding cover system comprising:
a pet bed;
a body comprising a top surface, a continuous opening in the top surface and a side surface, wherein the body is removably attached to the pet bed;
a rubber mat, wherein the rubber mat is exposed via the continuous opening;
a plurality of bristles; and
an internal pocket that receives the rubber mat.

6. The pet bed shedding cover system of claim 5, wherein the rubber mat and the body generate a static cling.

7. The pet bed shedding cover system of claim 6, wherein the body and the rubber mat collect hair from a pet when the pet is positioned on the plurality of bristles.

8. The pet bed shedding cover system of claim 5, wherein the internal pocket secures the rubber mat via at least one fastener.

9. A shedding cover device comprising:
a body that is sized and configured to be attached to a pet bed, the body comprising a top surface having a continuous opening and a side surface having at least one elastic band;
a rubber mat, wherein the rubber mat is exposed via the continuous opening;
a plurality of bristles extending outwardly from the rubber mat; and
an internal pocket that receives and secures the rubber mat via at least one fastener.

10. The shedding cover device of claim 9, wherein the plurality of bristles extend outwardly from a top surface of the rubber mat.

11. The shedding cover device of claim 9, wherein the rubber mat and the body generate a static cling.

12. The shedding cover device of claim 11, wherein the body and the rubber mat collect hair from a pet when the pet is in contact with the plurality of bristles.

13. The shedding cover device of claim 9, wherein the body is comprised of a material that conducts static electricity.

14. The shedding cover device of claim 10, wherein the at least one elastic band provides a compressive force to ensure the shedding cover device remains secured to the pet bed.

15. The shedding cover device of claim 9, wherein the plurality of bristles are comprised of a rubber, a metal or a plastic material.

16. The shedding cover device of claim 15, wherein the plurality of bristles de-shed a pet when the pet lays on a pet bed.

17. The shedding cover device of claim 9, wherein the at least one fastener is a hook and loop fastener, a zipper assembly fastener, a snap-button assembly fastener, a button and loop assembly fastener, or a magnetic fastener.

18. The shedding cover device of claim 9, wherein a bottom surface of the internal pocket is comprised of a loop surface.

19. The shedding cover device of claim 18, wherein a bottom surface of the rubber mat is comprised of a hook surface.

20. The shedding cover device of claim 19, wherein the rubber mat is removably secured to the internal pocket via the hook surface and the loop surface securing together.
